(19) United States
(12) Patent Application Publication
(10) Pub. No.: US 2012/0003407 A1
(43) Pub. Date: Jan. 5, 2012

(54) DECORATIVE BLEMISH COVER

(76) Inventor: Champagne ODEN, Akron, OH (US)

(21) Appl. No.: 13/165,867

(22) Filed: Jun. 22, 2011

Related U.S. Application Data
(60) Provisional application No. 61/398,704, filed on Jul. 1, 2010.

(51) Int. Cl. B32B 1/08; D05B 1/00; B31B 15/00

(52) U.S. Cl. 428/34.1; 493/386; 112/475.01

(57) ABSTRACT

A decorative blemish cover for covering blemishes on toes includes a rolled length of decorative fabric, such as colored fabric, printed fabric, lace or ribbon. The blemish cover is sized to fit over a user's toe, but does not extend beyond the tip of the toe.

### REFERENCE TO PRIOR-FILED PROVISIONAL APPLICATION

This application claims priority of U.S. Provisional Application No. 61/398,704, filed Jul. 1, 2010. 37 CFR 1.78.

### TECHNICAL FIELD

The present invention relates to covers for blemishes of the foot. More particularly, the present invention relates to decorative covers that have a more aesthetically pleasing appearance than conventional bandages.

### BRIEF DESCRIPTION OF THE DRAWING

FIG. 1 shows a blemish cover constructed according to the concepts of the present invention on a user's toe.

FIG. 2 shows another blemish cover constructed according to the concepts of the present invention on a user's toe.

### BEST MODE FOR CARRYING OUT THE INVENTION

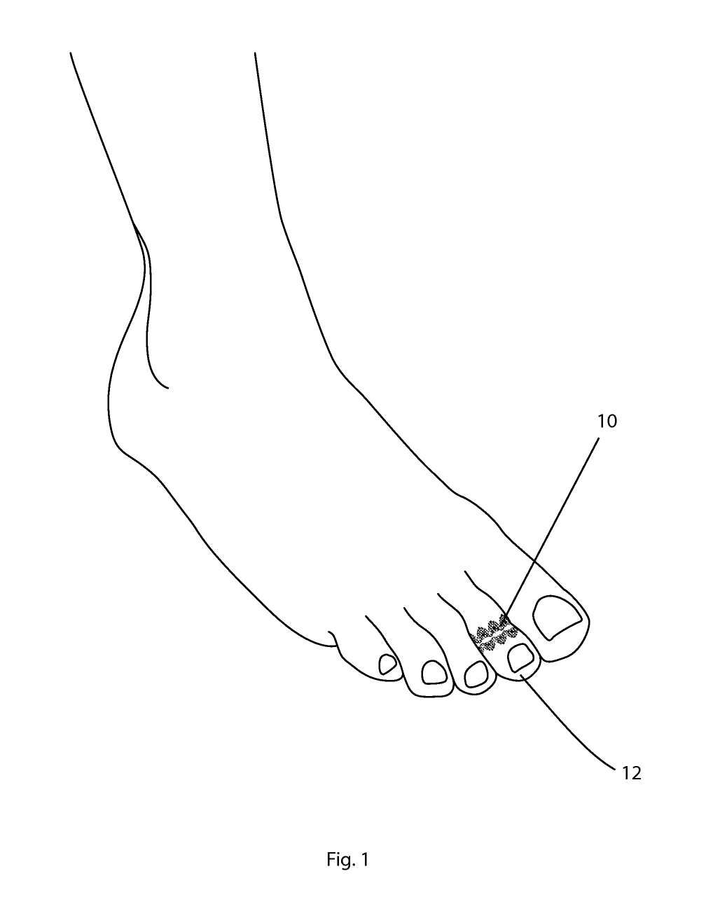

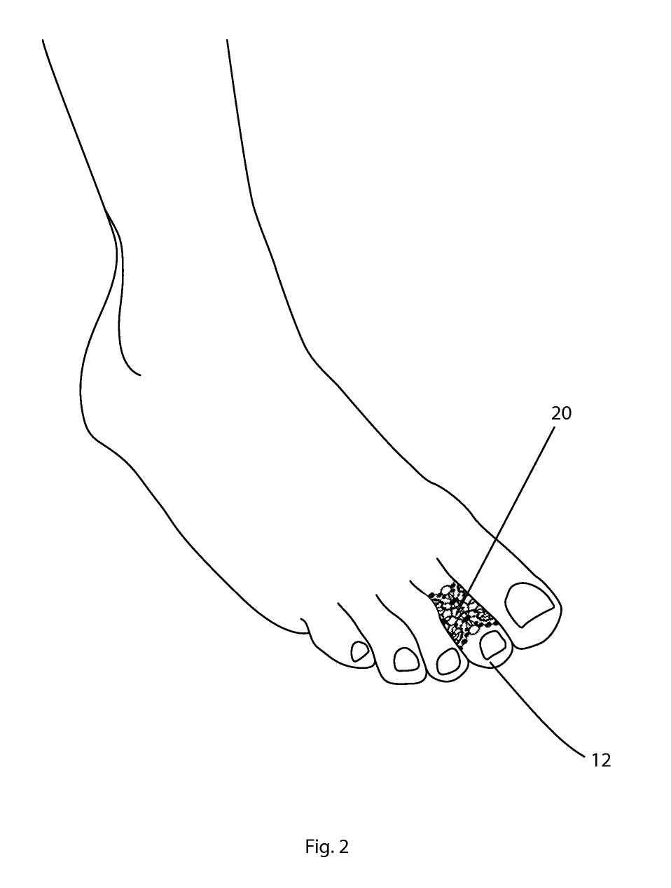

A blemish cover is disclosed that may be used to conceal one or more blemishes of the foot, such as corns, warts and the like, and is generally indicated by the numeral 10. Cover 10 may be made of any suitable material, but is preferably made from a fabric or other material having a decorative aspect. For instance, the cover may be made of colored fabric, printed fabric, lace, ribbon, or the like (hereafter “fabric material”). For example, FIG. 1 shows a cover 10 made of lacy material having a wavy shape. FIG. 2 shows another possible configuration of a cover, the cover 20 being made of a different lacy material and having a greater width than the lacy material of cover 10. The fabric material may be made from natural, synthetic or any other suitable fibers or materials to give it the desired physical properties, such as softness, stretchiness, adhesion to skin, water-resistance, and the like.

A cover, such as covers 10 and 20, may be made by wrapping a length of fabric material one or more times around a suitable form, the form being chosen to represent the general size and shape of a human toe. Then, the exposed end of the length of fabric material may be stitched to the rolled length of fabric material, or may be attached thereto by any other suitable means, such as by Velcro-attachment. Thus, the cover is made to take on a generally tubular shape.

Covers according to the present invention may be used as follows. Referring to FIG. 1, a user having a corn and wishing to conceal the corn takes a cover 10 and puts it over a portion of a toe 12 by inserting the toe 12 into the tubular-shaped cover 10, and positioning the cover 10 to conceal the blemish. It is conceived that the particular cover chosen could match the user's other garments or be selected to provide a desired aesthetic appearance. For instance, a user wearing sandals will have her toes exposed, and therefore may choose to use a cover having an appearance that coordinates with or matches her shorts, skirt, shirt, purse or some other personal effect. The same would also apply for users wearing other types of open-toed shoes.

The size and shape of the cover are chosen so that the cover conceals blemishes on toes. However, the qualities of the cover are chosen so that it may also be used when the user's toes are covered, such as when the user is wearing shoes and/or socks. In particular, the width of the cover is chosen so as to sufficiently cover a blemish on the toe, but not to extend over the tip of the toe. As seen in FIGS. 1 and 2, the width of covers 10 and 20 extends only a portion of the length of toe 12. Similarly, the length of the fabric chosen to make the cover is sufficiently long to fully wrap around a toe, but is not so long so as to form an excessively thick bandage which might otherwise protrude up from the toe and cause uncomfortable interference with the user's shoes.

What is claimed is:

1. A blemish cover comprising:
a rolled length of a decorative fabric material.

2. The blemish cover of claim 1, wherein said rolled length of decorative fabric material is sized to fit over one of a user's toes.

3. The blemish cover of claim 2, wherein said decorative fabric material is selected from the group consisting of colored fabric, printed fabric, lace and ribbon.

4. The blemish cover of claim 2, wherein said blemish cover has a generally tubular shape.

5. The blemish cover of claim 2, wherein said rolled length of fabric material has a width and said width is sized to not extend over the tip of the one of the user's toes.

6. A method of making a blemish cover comprising the steps of:
wrapping a length of decorative fabric material one or more times around a form to create a rolled length of fabric material,
and attaching an exposed end of the length of decorative fabric material to the rolled length of fabric material.

7. The method of claim 6, wherein said blemish cover has a generally tubular shape.

8. The method of claim 6, wherein said decorative fabric material is selected from the group consisting of colored fabric, printed fabric, lace and ribbon.

9. The method of claim 6, wherein said form represents the general size and shape of a human toe.

10. The method of claim 6, wherein said exposed end is attached to said rolled length of fabric material by stitching.
